(19) United States
(12) Patent Application Publication
(10) Pub. No.: US 2008/0072871 A1
(43) Pub. Date: Mar. 27, 2008

(54) Fuel Injector Having an Integrated Ignition Device

(75) Inventors: Manfred Vogel, Ditzingen (DE); Werner Herden, Gerlingen (DE); Rainer Ecker, Kornwestheim (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/596,453

(22) PCT Filed: Mar. 18, 2005
(86) PCT No.: PCT/EP05/51262

§ 371 Date: Nov. 6, 2007

(30) Foreign Application Priority Data
May 18, 2004 (DE) 10 2004 024 535.5

(51) Int. Cl. F02M 57/06

(52) U.S. Cl. 123/297

(57) ABSTRACT

A fuel injector having an integrated ignition device includes a first electrode pair for igniting fuel which is injected directly into a combustion chamber of an internal combustion chamber through spray-discharge orifices of the fuel injector. The first electrode pair is made up of a ground electrode and a center electrode which are set apart by a spark gap. The fuel injector and the ignition device are situated in a shared housing. The ignition device has at least one additional spark gap and/or an additional electrode pair.

### FIELD OF THE INVENTION

The present invention relates to a fuel injector having an integrated ignition device.

### BACKGROUND INFORMATION

Published German patent document 102 14 167 describes a fuel injector which has an integrated ignition device. A first electrode and a second electrode form a spark gap on the discharge side of the spray-discharge orifices. One of the advantages of such a fuel injector-spark plug combination is the reduced installation space and the increased flexibility in the combustion-chamber design and the arrangement and sizing of the intake and exhaust valves.

Particularly disadvantageous in the fuel injector described in the aforementioned German patent document is that the fuel-air mixture is ignited in only one location in the combustion chamber because of the only one spark gap. The time for the flame propagation in the combustion chamber is thus increased in a disadvantageous manner.

### SUMMARY

The fuel injector including an integrated ignition device according to the present invention has the advantage that the entire fuel-air mixture is ignited much faster. Since the overall combustion is therefore taking place much more rapidly, the efficiency is increased. In addition, lean end areas of the spray are avoided which ensures a smaller spread in the lambda range of the spray, resulting in reduced hydrocarbon emissions. Furthermore, the fuel injector having an integrated ignition device according to the present invention allows a higher exhaust-recirculation rate and/or lean stratified-charge operation which results in reduced nitrogen-oxide emissions.

In an example embodiment, the electrode pairs are positioned in such a way that the spark gaps are distributed evenly about the spray-discharge orifices, and/or the spark gaps are positioned on a circle about the spray-discharge orifices. This provides a uniform ignition of the fuel-air mixture, and the fuel-air mixture may combust evenly and homogenously inside the combustion chamber. The time for the full ignition of the entire fuel-air mixture inside the combustion chamber is minimized.

It is also advantageous to manufacture the housing from an electrically conductive material such as metal, for example. The housing may then be used as electrical pole or as ground electrode for the electrode pairs.

Because the length of the spark plug amounts to only 50 to 300 micrometers, the ignition voltage may be selected to be low. In addition, a reduced thickness of the insulating bodies may be chosen.

Moreover, it is advantageous to integrate a pressure sensor and/or a temperature sensor in the shared housing. This makes it easy to monitor states in the combustion chamber. Furthermore, no additional openings into the combustion chamber, which would be required for external sensors, will be necessary.

### BRIEF DESCRIPTION OF THE DRAWINGS

FIG. 1 shows a schematic cross-sectional view of an example of a fuel injector without integrated ignition device.

FIG. 2 shows a schematic cross-sectional view of the discharge-side region of an exemplary embodiment of the fuel injector having an integrated ignition device according to the present invention.

FIG. 3 shows a plan view of the discharge-side end of the fuel injector having an integrated ignition device according to the present invention.

### DETAILED DESCRIPTION

An exemplary embodiment of the present invention is described in the following by way of example. Identical components have been provided with matching reference numerals.

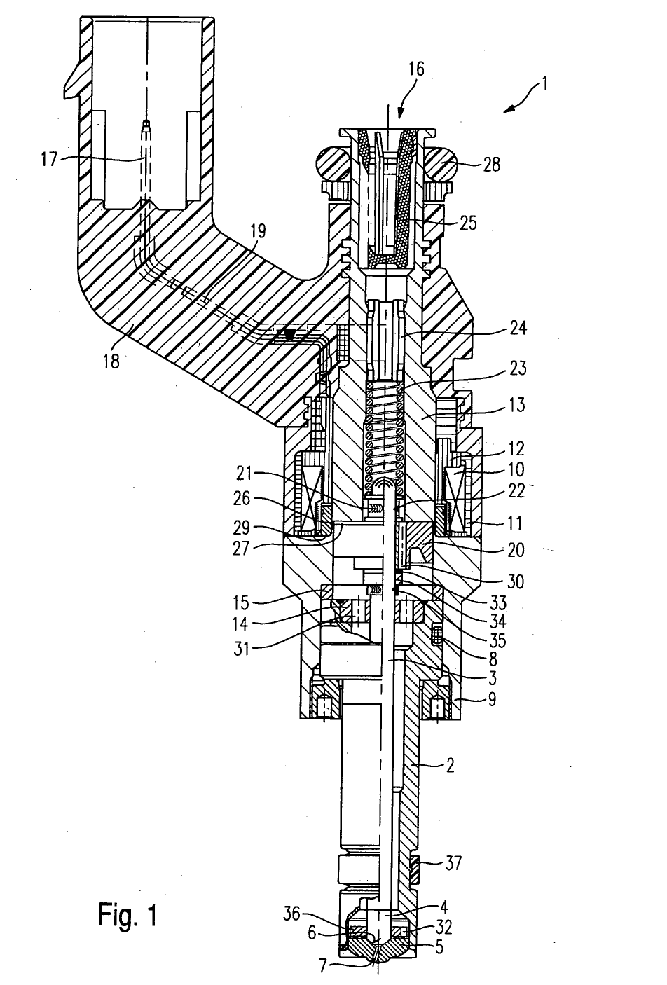

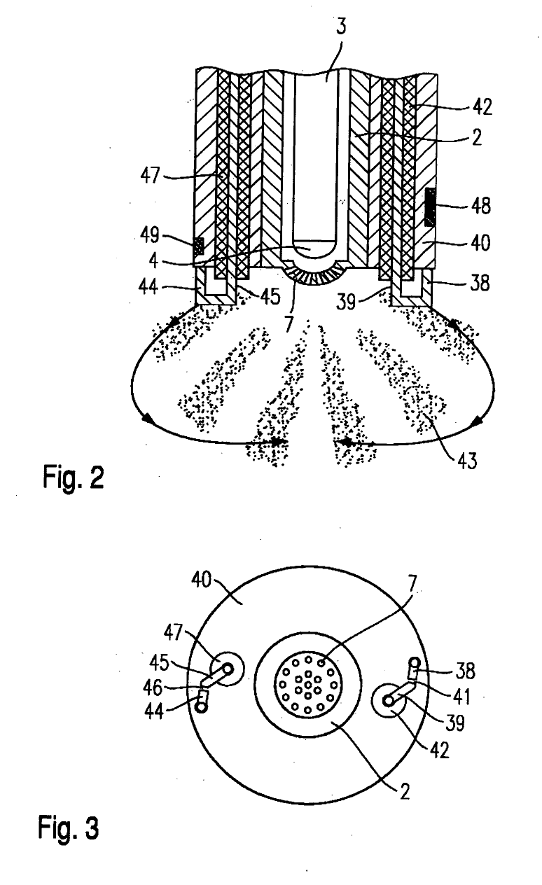

Before giving a more detailed description of an exemplary embodiment according to the present invention in connection with FIGS. 2 and 3, to provide a better understanding of the present invention, a fuel injector without integrated ignition device shall be explained briefly with reference to FIG. 1.

An example of a fuel injector 1 lacking an integrated ignition device, shown in FIG. 1, is designed in the form of a fuel injector 1 for fuel-injection systems of mixture-compressing internal combustion engines having externally supplied ignition. Fuel injector 1 is particularly suited for the direct injection of fuel into a combustion chamber (not shown) of an internal combustion engine.

Fuel injector 1 lacking an integrated ignition device is made up of a nozzle body 2 in which a valve needle 3 is positioned. Valve needle 3 has on its discharge side a valve-closure member 4, which cooperates with a valve-seat surface 6 disposed on a valve-seat member 5 to form a sealing seat. In the exemplary embodiment of FIG. 1, fuel injector 1 is an inwardly opening fuel injector 1, which is provided with a spray orifice 7. A seal 8 seals nozzle body 2 against an outer pole 9 of a solenoid coil 10. Solenoid coil 10 is encapsulated in a coil housing 11 and wound on a coil brace 12 which rests against an inner pole 13 of solenoid coil 10. Inner pole 13 and outer pole 9 are separated from one another by distance 26 and interconnected by a non-ferromagnetic connecting part 29. Solenoid coil 10 is energized via an electric line 19 by an electric current, which may be supplied via an electrical plug contact 17. Plug contact 17 is enclosed by a plastic coat 18, which is extrudable onto inner pole 13.

Valve needle 3 is guided in a valve-needle guide 14, which is disk-shaped. A paired adjustment disk 15 is used to adjust the (valve) lift. Armature 20 is disposed on the other side of adjustment disk 15. Via a first flange 21, it is in connection with valve needle 3, which is joined to first flange 21 by a welded seam 22. A helical restoring spring 23 is braced on first flange 21 and prestressed by a sleeve 24 in the example of fuel injector 1 shown in FIG. 1.

Fuel channels 30, 31 and 32 extend in valve-needle guide 14, armature 20 and along a guide element 36. The fuel is supplied via a central fuel supply 16 and filtered by a filter element 25. A rubber ring 28 seals fuel injector 1 against a fuel distributor line (not shown further), and a seal 37 seals it against a cylinder head (not shown further).

On the spray-discharge side of armature 20 is an annular damping element 33 made of an elastomeric material. It rests on a second flange 34, which is integrally joined to valve needle 3 via a welded seam 35.

In the quiescent state of fuel injector 1, armature 20 is acted upon by a restoring spring 23 against its direction of lift, in such a way that valve-closure member 4 is held in sealing contact on valve-seat surface 6. When excited, solenoid coil 10 generates a magnetic field which moves armature 20 in the lift direction, counter to the spring force of restoring spring 23, the lift being defined by a working gap 27 occurring in the rest position between inner pole 12 and armature 20.

First flange 21, which is welded to valve needle 3, is taken along by armature 20 in the lift direction as well. Valve-closure member 4, which is joined to valve needle 3, lifts off from valve seat surface 6, so that the fuel supplied under pressure is spray-discharged into the combustion chamber (not shown) through spray-discharge orifice 7.

If the coil current is interrupted, following sufficient decay of the magnetic field, armature 20 falls away from inner pole 13 due to the pressure of restoring spring 23, whereupon first flange 21, which is joined to valve needle 3, moves in a direction counter to the lift direction. Valve needle 3 is thereby moved in the same direction, causing valve-closure member 4 to set down on valve seat surface 6 and fuel injector 1 to be closed.

FIG. 2 shows a schematic cross-sectional view of the discharge-side region of an exemplary embodiment of a fuel injector 1 having an integrated ignition device according to the present invention. Illustrated fuel injector 1 is configured as a multi-hole valve and opens toward the inside of the combustion chamber. The integrated ignition device has two electrode pairs. A first electrode pair is made up of a first ground electrode 38 and a first center electrode 39. A second electrode pair is made up of a second ground electrode 44 and a second center electrode 45.

Cylindrical nozzle body 2 of fuel injector 1 extends inside hollow-cylindrical housing 40 with a precise fit and ends on the spray-discharge-side end of housing 40. Situated in housing 40 are a first hollow-cylindrical insulating body 42 in which first center electrode 39 extends, and a second hollow-cylindrical insulating body 47 in which second center electrode 45 extends. Insulating bodies 42, 47 are made from a ceramic material, for example. In other exemplary embodiments it is possible, for instance, to configure nozzle body 2 and housing 40 as one piece. Both insulating bodies 42, 47 project slightly beyond the discharge-side end of housing 40. This serves the purpose of avoiding creeping currents between the electrodes.

On the discharge side, both center electrodes 39, 45 initially exit from the two insulating bodies 42, 47 coaxially with respect to the center axis of the particular insulating body 42, 47; after a short distance, they then extend approximately at a right angle thereto. Both ground electrodes 38, 44 are affixed on opposite sides of spray-discharge orifices 7 in an electrically conductive manner by welding in the region of the outer edge of the discharge side of housing 40. Starting from housing 40, they initially extend parallel to the extension of the individually assigned center electrodes 39, 45, and then bend at a right angle on the same level as center electrodes 39, 45. The ends of individual center electrodes 39, 45 and the ends of individual ground electrodes 38, 44 are situated opposite each other and are spaced apart by spark gaps 41, 46 shown in greater detail in FIG. 3.

As indicated by arrows in FIG. 2, the fuel emerging from the plurality of spray-discharge orifices 7 in the form of spray 43 is ignited at both spark gaps 41, 46, and the arrows indicate the progression of the flame front of the ignited fuel-air mixture. The edge of spray 43, or spark gaps 41, 46, is situated such that spray 43 flows past spark gaps 41, 46 as closely as possible without coming into direct contact with or wetting them with fuel. Spray 43 flowing past at only a short distance also generates a so-called entrainment flow which deflects the ignition spark from the individual spark gap 41, 46 and in this way reliably ignites the fuel-air mixture. Since spark gaps 41, 46 are located at opposite sides of spray-discharge orifices 7, two flame fronts propagate in the combustion chamber, which initially are directed away from one another, but then extend to a piston floor (not shown) and ultimately flow toward one another, as indicated by the arrows in FIG. 2.

The time for the complete ignition of the fuel-air mixture in the combustion chamber (not shown) is nearly halved as a result. The two spark gaps 41, 46 are ignited simultaneously, an ignition with a time-offset being conceivable so as to take into account different propagation times of the two flame fronts in combustion-chamber geometries that are not symmetrical, for example. This may also become necessary if fuel injector 1 according to the present invention is not centrically disposed in a combustion-chamber roof (not shown).

Introduced radially in the region of the discharge-side end of housing 40 are a temperature sensor 49 and a pressure sensor 48.

FIG. 3 shows a plan view of the discharge-side end of the fuel injector 1 having an integrated ignition device according to the present invention. Clearly visible are spark gaps 41, 46 on opposite sides of spray-discharge orifices 7. However, in other exemplary embodiments according to the present invention, it is also possible to place more than two spark gaps 41, 46 around discharge orifices 7, which spark gaps are then disposed about spray-discharge orifices 7 in a uniform or circular arrangement, for example. The end of first center electrode 39 and the end of first mass electrode 38 are facing toward each other. The end of second center electrode 45 and the end of ground electrode 44 are also directed toward each other. The areas of the ends of the individual electrodes 38, 39, 44, 45 oriented toward each other extend in parallel to each another.

The clearances of the ends of the individual electrode pairs advantageously amount to only 50 to 300 micrometer. The magnitude of the ignition voltage may be lowered as a result, and the thickness of insulating bodies 42, 47 be reduced without detrimental effect on the reliability of fuel injector 1 having an integrated ignition device, since spray 43 flowing past generates the so-called entrainment flow, which deflects the only brief ignition spark and pulls it into the spray.

The ignition of both spark gaps 41, 46 may be carried out either via an individual ignition coil (not shown) by a series connection, it being necessary in this case to install or implement one of the two ground electrodes 38, 44 in an insulating manner, or it may be carried out by a double-spark coil.

The ignition of more than two spark gaps 41, 46 (n=number of spark gaps) may be realized either via an individual ignition coil, by a series connection, the ground electrodes of n−1 spark gaps then having to be installed in an insulating manner, or by using one or a plurality of double-spark coils or a combination of double-spark coils and single-spark ignition coils.

Described fuel injector 1 having an integrated ignition device as sub-assembly may additionally be combined with one or a plurality of ignition coils disposed behind in the axial direction.

The present invention is not restricted to the exemplary embodiments shown and may also be used, for instance, for outwardly opening or swirl-generating fuel injectors 1 having an integrated ignition device.

1-10. (canceled)

11. A fuel injector system with an integrated ignition device, comprising:
a fuel injector with a plurality of spray-discharge orifices for injecting fuel into a combustion chamber of an internal combustion engine;
an ignition device including a first electrode pair for igniting fuel injected into the combustion chamber, wherein the first electrode pair includes a ground electrode and a center electrode which are set apart by a first spark gap, and wherein the ignition device includes at least one of a second spark gap and a second electrode pair of a ground electrode and a center electrode; and
a shared housing for accommodating the fuel injector and the ignition device.

12. The fuel injector system as recited in claim 11, wherein the first and second electrode pairs are arranged in such a way that the first and second spark gaps are uniformly distributed about the plurality of spray-discharge orifices.

13. The fuel injector system as recited in claim 12, wherein the first and second spark gaps are arranged on a circle about the spray-discharge orifices.

14. The fuel injector system as recited in claim 13, wherein the plurality of spray-discharge orifices are positioned inside the circle in a concentric manner.

15. The fuel injector system as recited in claim 14, wherein the shared housing is made of an electrically conductive material.

16. The fuel injector system as recited in claim 15, wherein the ground electrodes of the first and second electrode pairs are in electrically conductive contact with the shared housing.

17. The fuel injector system as recited in claim 15, wherein the ground electrodes of the first and second electrode pairs are integrally joined to the shared housing.

18. The fuel injector system as recited in claim 16, wherein the ground electrodes of the first and second electrode pairs are integrally joined to the shared housing.

19. The fuel injector system as recited in claim 12, wherein the first and second spark gaps each have a length of between 50 micrometers and 300 micrometers.

20. The fuel injector system as recited in claim 16, wherein the first and second spark gaps each have a length of between 50 micrometers and 300 micrometers.

21. The fuel injector system as recited in claim 12, wherein each electrode of the first and second electrode pairs are at least partially made of platinum.

22. The fuel injector system as recited in claim 16, wherein each electrode of the first and second electrode pairs are at least partially made of platinum.

23. The fuel injector system as recited in claim 11, wherein at least one of: a) a pressure sensor is integrated in the share housing to measure the pressure in the combustion chamber; and b) a temperature sensor is integrated in the shared housing to measure the temperature in the combustion chamber.

24. The fuel injector system as recited in claim 12, wherein at least one of: a) a pressure sensor is integrated in the share housing to measure the pressure in the combustion chamber; and b) a temperature sensor is integrated in the shared housing to measure the temperature in the combustion chamber.

25. The fuel injector system as recited in claim 16, wherein at least one of: a) a pressure sensor is integrated in the share housing to measure the pressure in the combustion chamber; and b) a temperature sensor is integrated in the shared housing to measure the temperature in the combustion chamber.

26. The fuel injector system as recited in claim 18, wherein at least one of: a) a pressure sensor is integrated in the share housing to measure the pressure in the combustion chamber; and b) a temperature sensor is integrated in the shared housing to measure the temperature in the combustion chamber.
